(19) United States
(12) Patent Application Publication
(10) Pub. No.: US 2025/0131378 A1
(43) Pub. Date: Apr. 24, 2025

(54) COLLABORATIVE MULTI-CLOUD MEASUREMENTS

(71) Applicant: INTERNATIONAL BUSINESS MACHINES CORPORATION, ARMONK, NY (US)

(72) Inventors: David Breitgand, Modiin (IL); Seep Goel, Bengaluru (IN); Kavya Govindarajan, Chennai (IN); Praveen Jayachandran, Bangalore (IN); Dean Har'el Lorenz, Haifa (IL)

(21) Appl. No.: 18/490,845

(22) Filed: Oct. 20, 2023

(51) Int. Cl. G06Q 10/10; H04L 67/1097

(52) U.S. Cl. CPC G06Q 10/103; H04L 67/1097

(57) ABSTRACT

A method, computer system, and a computer program product are provided for providing multi-cloud collaboration. In one embodiment, the technique comprises obtaining registration information for a plurality of participants. The participants are devices located on a plurality of computer networks. A measurement query request is received from a query requester. The query requester is one of the plurality of participants. Contributions measurements is also received from a subset of the plurality of participants and measurement data is then updated based on the contributions received from the subset of participants. Measurement data is the provided in response to said measurement query. The amount of data provided depends on a set of policies regarding measurement contributions made by the query requester.

### BACKGROUND

The present invention relates generally to the field of digital cloud-based multimedia platforms and more particularly to techniques for providing collaborative multi-cloud measurements.

Delivery of computing services over the Internet may be provided through cloud computing. Cloud computing provides on-demand availability of computer system resources, such as data resources and computing power, without a need for active management by the users. Large cloud networks often have distributed functions over multiple locations. With these multi-cloud deployments gaining popularity, connectivity-related metrics (e.g., latency, throughput) play a crucial role in facilitating inter-cloud communication. However, measuring these metrics is both costly and complex, necessitating setup on every cloud and repeated measurements due to changing network conditions. Some third party third party providers try to limit the shortcomings of the current prior art by offering network measurement services. Others try to limit costs by providing crow-d sourced information. However, these efforts still share many of the other limitations. For example, the lack of prior knowledge about the underlying topology requires obtaining measurements each time between every pair of overlay gateways, making the process expensive even for moderately sized meshes. Moreover, in scenarios where multiple entities independently acquire connectivity-related data, efficiency and eliminating wasteful processes are crucial. Consequently, since each entity may only measure part of the information due to asymmetric topologies, and measurement costs may vary among participants, a collaborative approach is crucial.

Consequently, it is desirous to provide a cost effective solution that can provide collaborative multi-cloud measurements with statistical fidelity.

### SUMMARY

Embodiments of the present invention disclose a method, computer system, and a computer program product for providing a multi-cloud collaboration platform. In one embodiment, a method is provided that comprises obtaining registration information for a plurality of participants. The participants are devices located on a plurality of computer networks. A measurement query request is received from a query requester. The query requester is one of the plurality of participants. Contribution measurements are also received from a subset of the plurality of participants and measurement data and stored in a shared database. These are then updated based on the contributions received from the subset of participants. Measurement data is the provided in response to said measurement query. The amount of data provided depends on a set of policies regarding measurement contributions made by the query requester.

In another embodiment, a computer system for providing a multi-cloud collaboration is disclosed. The system comprises one or more processors, one or more computer-readable memories and one or more computer-readable storage media. It also comprises program instructions stored on at least one of the one or more storage media for execution by at least one of the one or more processors via at least one of the one or more memories, to obtain registration information for a plurality of participants. The participants are devices located on a plurality of computer networks. Program instructions are provided to receive contributions measurements from a subset of the plurality of participants and to store in a shared database accessible. The query requester is one or the plurality of participants. Furthermore, program instructions are provided to update measurement data based on received contributions from said subset of the plurality of participants; and to provide measurement data in response to the measurement query. The amount of data provided depends on a set of policies regarding a plurality of measurement contributions made by the query requester.

In another embodiment, a computer program product for providing multi-cloud collaboration is disclosed. The computer program product comprises one or more computer readable storage media. It also comprises It also comprises program instructions stored on at least one of the one or more storage media for execution by at least one of the one or more processors via at least one of the one or more memories to: obtain registration information for a plurality of participants; to receive a measurement query request from a query requester; to receive contributions measurements from a subset of the plurality of participants and to store in a shared database accessible by the plurality of participants. Furthermore, program instructions are provided to update measurement data based on received contributions from said subset of the plurality of participants; and to provide measurement data in response to the measurement query. The amount of data provided depends on a set of policies regarding a plurality of measurement contributions made by thed query requester.

### BRIEF DESCRIPTION OF THE SEVERAL VIEWS OF THE DRAWINGS

These and other objects, features and advantages of the present invention will become apparent from the following detailed description of illustrative embodiments thereof, which may be to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment, according to at least one embodiment;

FIG. 2 provides an operational flowchart for a multi-cloud collaborative process, according to one embodiment;

FIG. 3 provides a block diagram of different components for a multi-collaboration platform, according to one embodiment;

FIG. 4 provides a block diagram illustrating data flow for a collaborative platform, according to one embodiment;

FIG. 5A provides a block diagram example showing the direction of measurements for a collaborative platform, according to one embodiment; and

FIG. 5B provides a block diagram providing an example showing frequency of measurement in a collaborative platform, according to one environment.

### DETAILED DESCRIPTION

Detailed embodiments of the claimed structures and methods may be disclosed herein; however, it can be understood that the disclosed embodiments may be merely illustrative of the claimed structures and methods that may be embodied in various forms. This invention may, however, be embodied in many different forms and should not be construed as limited to the exemplary embodiments set forth herein. Rather, these exemplary embodiments may be provided so that this disclosure will be thorough and complete and will fully convey the scope of this invention to those skilled in the art. In the description, details of well-known features and techniques may be omitted to avoid unnecessarily obscuring the presented embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

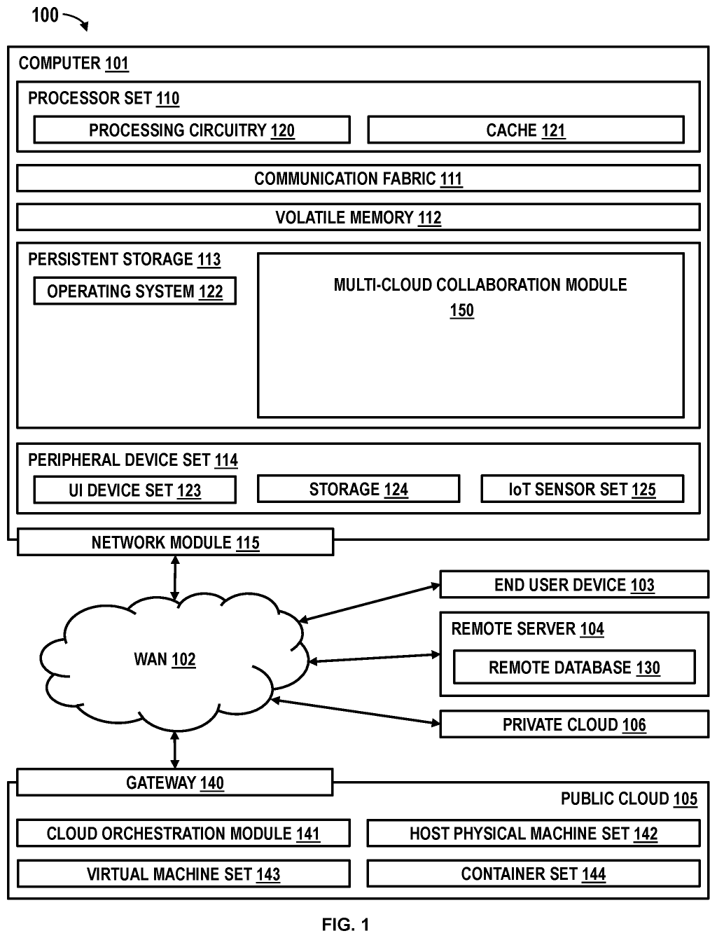

FIG. 1 provides a block diagram of a computing environment 100. The computing environment 100 contains an example of an environment for the execution of at least some of the computer code involved in performing the inventive methods, such as code change differentiator which is capable of providing a multi-cloud collaboration module (150). In addition to this block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 of FIG. 1 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As mentioned earlier, with multi-cloud deployments becoming popular, connectivity related metrics (e.g., latency, throughput) are necessary to facilitate inter-cloud communication. However, multi-cloud measurements are costly and complicated. Measurement of these metrics is quite costly and requires some setup on every cloud. Since the underlying topology is often unknown, measurements are required between every pair of overlay gateways. Moreover, as network conditions change over time, repeated measurements are required. Frequent measurements of the full mesh of gateways is prohibitively expensive even for the moderate size meshes. Multiple different entities would want this data and could currently be doing this independently, which is wasteful. Each entity might be able to measure only part of the information (e.g., in asymmetric topologies), so collaboration is needed to obtain a complete view. The cost of measurements may be different for different participants.

Prior art currently in use, attempts to resolve some issues but has many shortcomings. For example, cloud providers offer measurements between (some of) their gateways and peering points with other clouds. But these are limited to the data that a provider chooses to share. In many instances, this data might not provide enough information to support multi-cloud applications. Furthermore, many providers may not provide enough information on latency and bandwidth of ingress and egress traffic between private and public clouds and/or on traffic through custom connectivity solutions (such as dedicated lines, services, telco networks, or specialized clouds).

Similar limitations exist even for the provider of public clouds. Even when there are collaborative efforts, such as those provided by crowd-sourced entities and information systems, such services are not offered for multi-cloud networking purposes. In addition, services that provide these type of collaborative effort do not provide the ability to query the data, or do not handle it in a way that is anonymized and is done with fairness or is trustworthy. In addition, any successful collaborative effort must have rules for scheduling and synchronization.

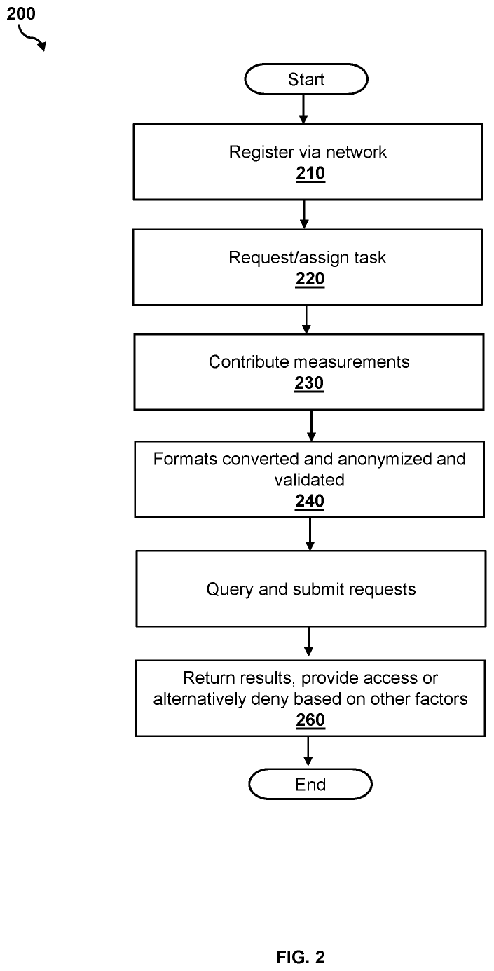

Coordinating efforts to optimize resources and obtain a comprehensive view in a cloud computing environment is crucial. Collaboration can enable inter-cloud connectivity to effectively monitor processes in these multi-cloud environments. FIG. 2 is a flowchart depiction of a process 200 that provides for a collaborative approach. Process 200 provides a technique to efficiently monitor inter-cloud connectivity in multi-cloud deployments.

In one embodiment, the methodology commences at Step 210. In Step 210, one or more users or participants (also referenced as tenants) can register to a service or a network such as via a network provider. In one embodiment, the service or the network is provided through a platform. In this scenario, the platform may be distributed or be provided as a single centralized entity. A plurality of nodes, hereinafter referenced as tenants can be using the platform. In one embodiment, these tenants may be gateway nodes, third-party measurement services or similar network components.

In Step 220, one or more tenants or other users of the network can request or assign measurement tasks from a service. This is a request for service plan measurements and can include a variety of tasks such as type of data and synchronization as well. In one embodiment, measurements are analyzed in view of cost optimization.

In Step 230, the participants of the network (users, tenants, etc.) contribute measurements requested or measurements that have already been used by the participant. These may include a variety of packaging or other components (probes, library etc.).

In Step 240, formats are converted and anonymized and validated. In one embodiment any redundant data is also removed. In addition, updates may be performed to the optimization plan (change in frequency, modification—adding/removal—of tasks, etc.).

In Step 250, the participants query the service. The query may include a variety of needed information. For example, in one embodiment, the query may include broad data and be inclusive to all parties (from all parties). In one embodiment, the type of query and specificity of it will grow with contributions In other words, the more the overall participation and collaboration, the more the parties can query as with regards to details and specifics.

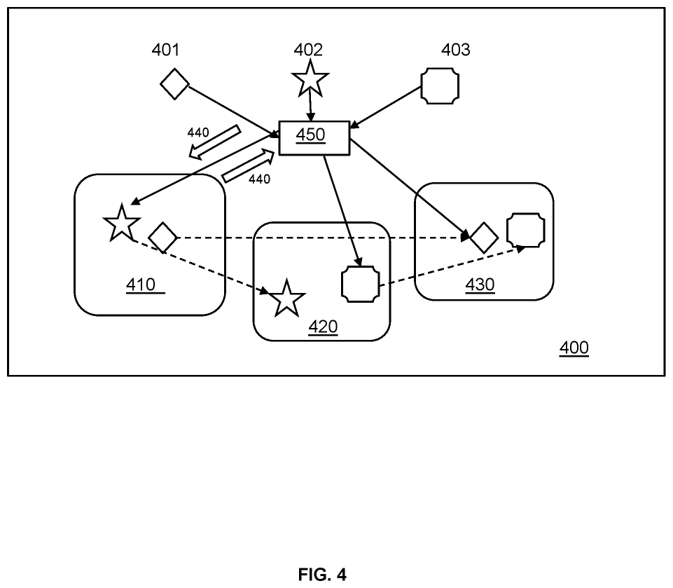

In Step 260, results of query is returned or alternatively access is provided to one or more databases. In one embodiment, the results and/or access may be dependent on a number of factors including service contracts, contributions or others as discussed in more detail in conjunction with FIG. 4. In this manner, the collaborative process 200 can accept and provide queries from multiple participants in a multi-cloud network. In turn the process provides measurements in response to queries to the participants with required resolution and statistical fidelity for the participating parties (but at a fraction of the cost).

Process 200 provides many advantages. For one it dramatically improves cost efficiency and at the same time provides a multi-cloud initiative with observable products. In one embodiment, the process 200 can provide a technique for a policy-based partitioning of a measurement effort in a multi-cloud environment aiming at optimizing the following tradeoffs:
Overall cost reduction
More information, at finer granularity
Handling of security, trust, privacy
   In this manner, the process 200 optimally allocates measurement tasks about participants (i.e., tenants of the network/system).

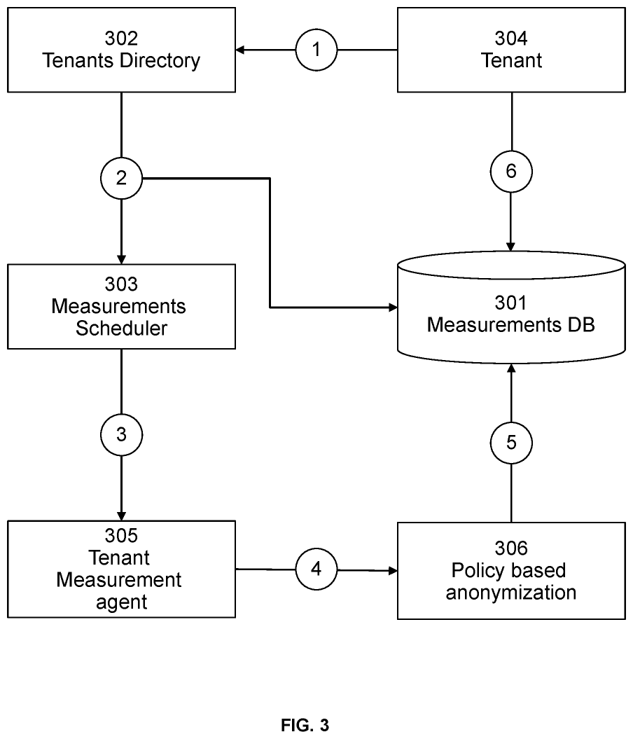

FIG. 3 provides a block diagram of different components of a collaborative platform, according to one embodiment. A participant/tenant 304 registers with a Directory 302 as shown. In one embodiment, the registered participant 304 could be part of a distributed network or another cloud. In a different alternate embodiment, the participant/tenant may be part of a centralized network. In one embodiment, tenants/participants can also be comprised of gateway nodes, third-party measurement services or other similar arrangements. In one embodiment, a plurality of smart contracts stipulating policies and compensations can also be provided (signed) at registration time. Any such policies, in these scenarios, will then be later enforced automatically.

The Tenants Directory 302, in one embodiment, propagates new information to a Measurements Scheduler 303 that plans measurements and a Measurements database (DB) referenced as 301. The Tenants Directory 302 can also request/assign measurement tasks (what data, synchronization, etc.); and optimize cost (subject to policy constraints). Tenants Directory 302 also informs Measurements DB 301 about tenant policies to be enforced at query time.

The Measurement Scheduler 303 instructs a Tenant Measurement Agent(s) 305 that is configured with frequency of measurements, appropriate instrumentation (probes, libraries, etc.). In one embodiment, the Tenant Measurement Agent(s) 305 contributes measurements for query responses.

A policy based anonymization component 306 is also provided. This component converts formats, anonymizes, validates, removes redundant data, and performs such similar tasks.

In one embodiment, the participants/Tenants 304 query the Measurements DB 301 subject to their contract with the collaborative measurements system. The quality of measurements (resolution, volume, metrics) is proportional to tenants' contribution and is stipulated and subject to such a contract. However, such contracts and policies may be revised to accommodate new requirements by the tenants.

FIG. 4 provides a block diagram providing for a system 400 (also referenced as service) that incorporates a collaborative system (service or platform) 450. Different participants (tenants) can join the service and can benefit from the service in terms of collaborative measures. In the scenario shown, three participants 401, 402 and 403 are shown to provide ease of understanding but many parties can be present in alternative environments. Different participants/tenants can have different requirements or participations, For example, in this example 401 requests measurements at a frequency f1, while 403 requests measurements at a measurement f3. Arrows shown at 440 show the frequency of communication and collection being sent from the system 450 to the participants (401 as shown) and the metrics being sent to the system 450 (from 401 in this example).

In this system a Collaborative Measurements scheme is provided (shown by 450). Each participant (tenant) 401-403 can contribute measurements to the system 450. The system can also include a database (not illustrated).

In one embodiment, the system 450 offers measurement tasks that participant can take upon themselves (what/where, timing/synchronization, frequency). As indicated, a shared database can be provided (not illustrated) as part of a scheme (system 450) and the contributors can query the database. The parties may each be part of at least a cluster. In this example, three clusters are illustrated as shown at 410, 420 and 430.

In one embodiment, access to the database may be provided based on a fairness assessment. In one embodiment, for example, value to be obtained may be proportional to the measurement effort or be based on other components (“Pay” for queries with measurements, allow more complex and more frequent queries to clients that contribute more complex/more frequent measurements.).

In one embodiment, the value that a participant or tenant will receive may be according to a contractual arrangement (smart contract). This may be implemented via embedded components such as those provided within a service level agreement (SLA) such as provided between a service provider and the user (participant/tenant) with a collaborative measurement component. In one embodiment, the quality of service (QoS) can be automated so these measurements can be provided and obtained via smart contracts embedded within SLA. In this scenario, the automation is provided inside the smart contract that has the ability to automatically regulate QoS proportionality to measurements contributed, without the need to revise SLA within a collaborative measurement platform. In another embodiment, the collaborative measurement process can provide an anonymization component that removes private information from measurements for added security.

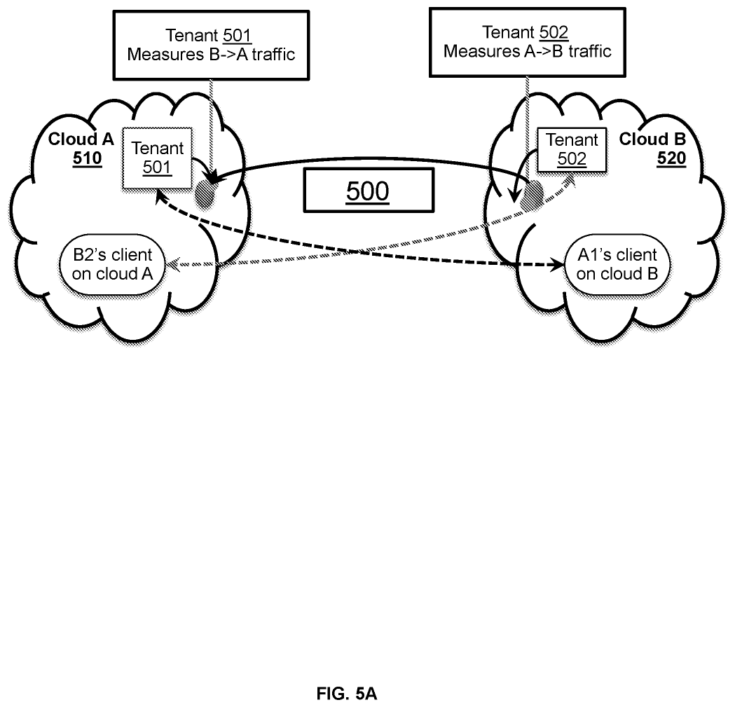

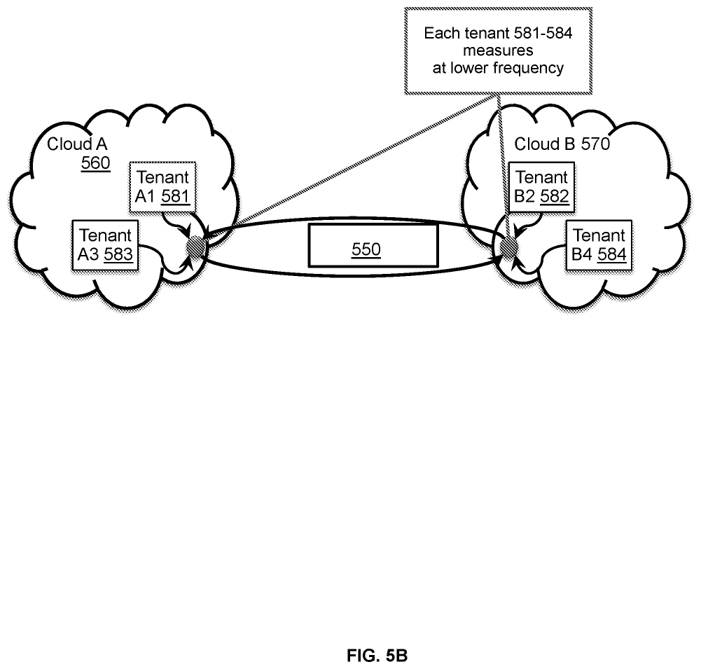

FIGS. 5A and 5B provide two examples of network service incorporating the process 200 of FIG. 2. In the example of FIG. 5A, the concentration is more on illustrating the direction of measurements, whereas in FIG. 5B the concentration is in providing effects of frequency and granularity of measurement.

FIG. 5A provides a block diagram of a first example, where there are two clouds A and B, respectively enumerated as 510 and 520. There are two tenants 501 on cloud A 510; and 502 on cloud B 520. Tenant A1 (501) can upload (ingress) content from cloud B (520) at no cost will pay for any egress traffic. Similarly, tenant B2 (502) can upload from cloud A (510) at no cost. In this scenario, both tenants 401 and 402 can collaboratively measure bandwidth by preforming one-way uploads and sharing with one another.

In this scenario, Tenant 501 (also referenced as participant) measures (free) cloud B->A traffic, while Tenant 502 measures (free) cloud A->B traffic. Platform (or system) 500 orchestrates collaborative measurements as shown. In addition, Tenant 1 501 requires 2-way measurements to support its clients on cloud B 520. Tenant 502 requires 2-way measurements to support its clients on cloud A 510.

FIG. 5B provides a block diagram of a second example 2. In this scenario multiple cloud can be present. For the ease of simplicity in the FIG. two clouds A (560) and cloud B (570) are provided. A plurality of Tenants (or participants) T1. T2, T3, etc. can also be present that in this scenario are referenced by numerals 581, 582, 583 and 584. In this example, all of the tenants 581-584 need fine-grained measurements (e.g., every x1, x2, x3, . . . seconds). The system (service) is referenced as 550 is a platform that orchestrates collaborative measurements. The system 500 schedules the measurement and splits the effort between the numerous tenants 581-584. Those that require better granularity (smaller x) are allocated more measurements. All participants can query the data, however, not all get it in the most fine-grained granularity.

The descriptions of the various embodiments of the present invention have been presented for purposes of illustration but may be not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for providing multi-cloud collaboration, comprising:
obtaining registration information for a plurality of participants, wherein said participants are devices located on a plurality of computer networks;
receiving a measurement query request from a query requester, wherein said query requester is one of said plurality of participants;
receiving contributions measurements from a subset of said plurality of participants and storing it in a shared database accessible by said plurality of participants;
updating measurement data based on received contributions from said subset of said plurality of participants; and
providing measurement data in response to said measurement query; wherein amount of data provided depends on a set of policies regarding a plurality of measurement contributions made by said query requester.

2. The method of claim 1, wherein said set of policies and said updated measurement data is stored in said shared database and retrieved accordingly in response to said measurement query.

3. The method of claim 2, wherein said plurality of participants can provide queries and request measurements from said database, but said database provides selective access to said data based on a plurality of policies each relating to different participants.

4. The method of claim 2, wherein the amount of measurement data received is proportional to measurement contribution made by said query requester.

5. The method of claim 3, wherein said set of policies are established regarding proportionality of measurement contribution for determining amount of data to be received by said query requester.

6. The method of claim 5, wherein said policies are implemented via a smart contract embedded in a software license agreement provided to said plurality of participants.

7. The method of claim 6, further comprising automatically regulating proportionality to measurements contributed.

8. A computer system for providing a multi-cloud collaboration, comprising:
one or more processors, one or more computer-readable memories and one or more computer-readable storage media;
program instructions, stored on at least one of the one or more storage media for execution by at least one of the one or more processors via at least one of the one or more memories, to obtain registration information for a plurality of participants; wherein said participants are devices located on a plurality of computer networks;
program instructions, stored on at least one of the one or more storage media for execution by at least one of the one or more processors via at least one of the one or more memories, to receive a measurement query request from a query requester, wherein said query requester is one of said plurality of participants;
program instructions, stored on at least one of the one or more storage media for execution by at least one of the one or more processors via at least one of the one or more memories, to receive contributions measurements from a subset of said plurality of participants and to store in a shared database accessible by said plurality of participants;
program instructions, stored on at least one of the one or more storage media for execution by at least one of the one or more processors via at least one of the one or more memories, to update measurement data based on received contributions from said subset of said plurality of participants; and
program instructions, stored on at least one of the one or more storage media for execution by at least one of the one or more processors via at least one of the one or more
memories, to provide measurement data in response to said measurement query; wherein amount of data provided depends on a set of policies regarding a plurality of measurement contributions made by said query requester.

9. The computer system of claim 8, wherein said set of policies and said updated measurement data is stored in said shared database and retrieved accordingly in response to said measurement query.

10. The computer system of claim 8, wherein said plurality of participants can provide queries and request measurements from said database, but said database provides selective access to said data based on said plurality of policies each relating to different participants.

11. The computer system of claim 9, wherein the amount of measurement data received is proportional to measurement contribution made by said query requester.

12. The computer system of claim 11, wherein set of policies are established regarding proportionality of measurement contribution for determining amount of data to be received by said query requester.

13. The computer system of claim 12, wherein said policies are implemented via a smart contract embedded in a software license agreement provided to said plurality of participants.

14. The computer system of claim 13, further comprising program instructions, stored on at least one of the one or more storage media for execution by at least one of the one or more processors via at least one of the one or more memories, to automatically regulate proportionality to measurements contributed.

15. A computer program product for providing multi-cloud collaboration, the computer program product comprising:
one or more computer readable storage media;
program instructions, stored on at least one of the one or more storage media for execution by at least one of the one or more processors via at least one of the one or more memories, to obtain registration information for a plurality of participants; wherein said participants are devices located on a plurality of computer networks;
program instructions, stored on at least one of the one or more storage media for execution by at least one of the one or more processors via at least one of the one or more memories, to receive a measurement query request from a query requester, wherein said query requester is one of said plurality of participants;
program instructions, stored on at least one of the one or more storage media for execution by at least one of the one or more processors via at least one of the one or more memories, to receive contributions measurements from a subset of said plurality of participants and to store in a shared database accessible by said plurality of participants;
program instructions, stored on at least one of the one or more storage media for execution by at least one of the one or more processors via at least one of the one or more memories, to update measurement data based on received contributions from said subset of said plurality of participants; and
program instructions, stored on at least one of the one or more storage media for execution by at least one of the one or more processors via at least one of the one or more memories, to provide measurement data in response to said measurement query; wherein amount of data provided depends on a set of policies regarding a plurality of measurement contributions made by said query requester.

16. The computer program product of claim 15, wherein said set of policies and said updated measurement data is stored in said shared database and retrieved accordingly in response to said measurement query.

17. The computer program product of claim 15, wherein said plurality of participants can provide queries and request measurements from said database, but said database provides selective access to said data based on a plurality of policies each relating to different participants.

18. The computer program product of claim 16, wherein the amount of measurement data received is proportional to measurement contribution made by said query requester.

19. The computer program product of claim 18, wherein a set of policies are established regarding proportionality of measurement contribution for determining amount of data to be received by said query requester.

20. The computer program product of claim 19, wherein said policies are implemented via a smart contract embedded in a software license agreement provided to said plurality of participants.
